(19) United States
(12) Patent Application Publication
(10) Pub. No.: US 2023/0274331 A1
(43) Pub. Date: Aug. 31, 2023

(54) SYSTEM AND METHOD FOR AUTOMATED GENERATION OF SALES PROPOSALS

(71) Applicant: Dell Products L.P., Round Rock, TX (US)

(72) Inventor: Amanda Meihui Lok, Georgetown, TX (US)

(21) Appl. No.: 17/682,600

(22) Filed: Feb. 28, 2022

(51) Int. Cl. G06Q 30/06; G06Q 30/02; G10L 15/08; G10L 15/06

(52) U.S. Cl. CPC G06Q 30/0631; G06Q 30/0201; G10L 15/08; G10L 15/063; G10L 2015/088

(57) ABSTRACT

A method for automated generation of a sales proposal using customer voice input data includes: identifying, automatically using voice recognition, a customer's voice within a customer call between the customer and a merchant's employee to obtain the customer voice input data; parsing the customer voice input data to obtain one or more search terms; automatically generating and populating the sales proposal based on the one or more search terms; and displaying, after the automatic generating and populating, the sales proposal to the merchant's employee where the sales proposal is to be presented to the customer by the merchant's employee.

### BACKGROUND

Sales proposals are integral to a merchant's (e.g., a seller, retailer, manufacturer, producer, etc.) sales cycle. However, sales proposals are manually created, which take up time and decrease efficiency when having to create a complete proposal for each of the merchant's customers. Additionally, contents for these sales proposals usually come from a salesperson's handwritten notes and interpretations of a customer's requirements, both of which can be misconstrued by an individual sales person.

### BRIEF DESCRIPTION OF DRAWINGS

Certain embodiments of this disclosure will be described with reference to the accompanying drawings. However, the accompanying drawings illustrate only certain aspects or implementations of one or more embodiments disclosed herein by way of example and are not meant to limit the scope of the claims.

FIG. 1 shows a system in accordance with one or more embodiments described herein.

FIGS. 2.1-2.3 show flowcharts in accordance with one or more embodiments described herein.

FIGS. 3.1-3.2 show an implementation in accordance with one or more embodiments described herein.

FIG. 4 shows a computer system in accordance with one or more embodiments described herein.

### DETAILED DESCRIPTION

Specific embodiments will now be described with reference to the accompanying figures.

In the description below, numerous details are set forth as examples of embodiments described herein. It will be understood by those skilled in the art, that have the benefit of this Detailed Description, that one or more embodiments described herein may be practiced without these specific details and that numerous variations or modifications may be possible without departing from the scope of the embodiments described herein. Certain details known to those of ordinary skill in the art may be omitted to avoid obscuring the description.

In the description of the figures below, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components.

Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

One or more embodiments disclosed herein are directed to systems and methods for automated generation of a sales proposal using customer voice input data taken from a customer call between a customer and a merchant's employee (e.g., a service personnel, a sales representative, a customer support representative, a technician, the merchant's vendor, etc.). In particular, the automated sales proposal generation method of one or more embodiments disclosed herein generates sales proposals using search terms identified within a customer's speech during a customer call (e.g., a sales call, a service call, etc.). Voice recognition techniques (e.g., voice recognition programs and applications) may be used to isolate a customer's voice in a customer call to obtain the customer voice input data based on contents of the customer's speech. Search terms identified within the customer voice input data may then be used to automatically search for one or more products within a products database that meet the customer's needs and demands. The identified products that meet the customer's needs and demands may then be automatically populated into a sales proposal to be reviewed by the merchant's employee before presenting the sales proposal to the customer. This advantageously removes any human error (e.g., different interpretations by different merchant's employees, mishearing a customer's words by the merchant's employees, merchant's employee's bias, etc.) from the process of generating sales proposals, and results in a direct improvement in the efficiency and accuracy of the sales proposal generation process.

In the context of one or more embodiments disclosed herein, the term “product” may refer to both products and services. More specifically, the term “product” may refer to either a single product, a single service, a combination of both a product and a service, or a combination of multiple products and/or services. Examples of products being provided by owners may include, but are not limited to: downloadable computer-executable programs, applications (e.g., mobile phone applications), a physical product (e.g., user devices such as a laptop, a desktop computer, a mobile phone, tablet, a vehicle, an appliance, furniture, etc.), etc. Examples of services may include, but are not limited to: software as a service (SaaS); one or more applications running on a web browser environment, updates for computer-executable programs, etc.

Various embodiments of the disclosure are described below.

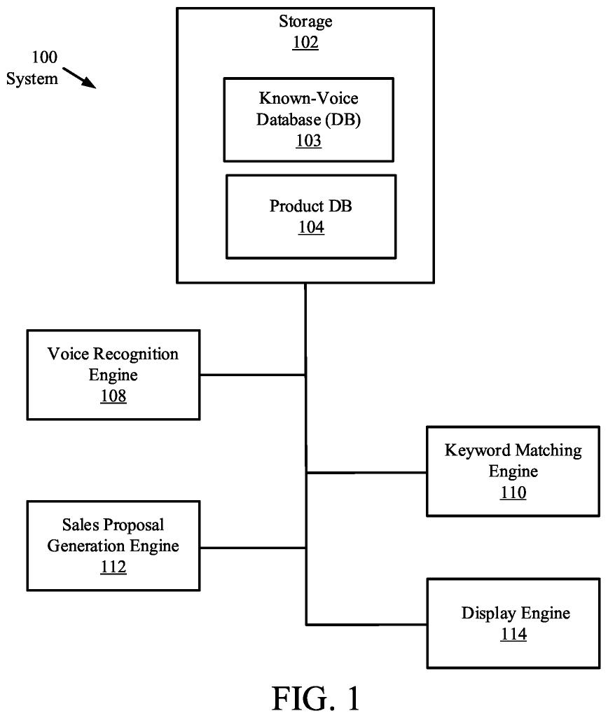

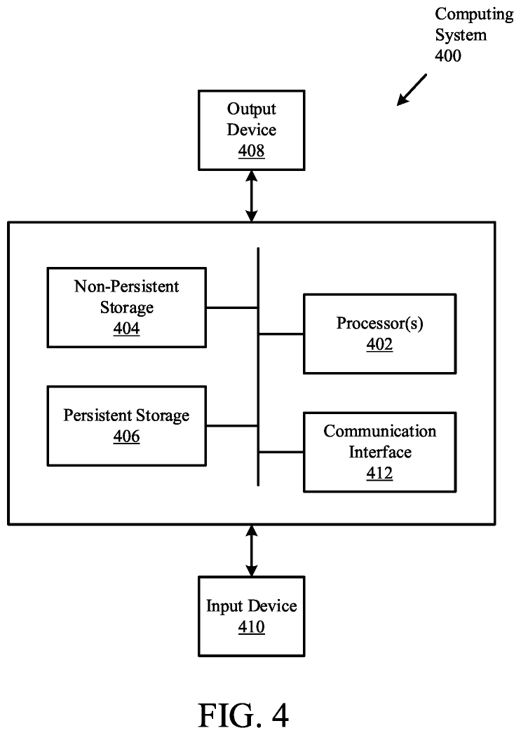

FIG. 1 shows a system (100) in accordance with one or more embodiments. The system includes a storage (102), a voice recognition engine (108), a keyword matching engine (110), a sales proposal generation engine (112), and a display engine (114). In one or more embodiments disclosed herein, the system (100) may be part of a computing system (e.g., 400, FIG. 4). Each of these components of the system (100) will be described in more detail below.

As shown in FIG. 1, the system (100) includes the storage (102). The storage (102) may be implemented using volatile or non-volatile storage or any combination thereof. The storage (102) is configured to store a known-voice database (DB) (103) and a product DB (104).

In one or more embodiments, the known-voice DB (103) may be a data structure (i.e., one or more lists, tables, collection of data values, etc.) storing voices of known merchant's employees associated with a merchant to be used by the voice recognition engine (108) (described in more detail below). The known-voice DB (103) may also store voices of customers to be used by the voice recognition engine (108) during future calls with one or more of the same customers (e.g., repeat customers, members, etc.).

In one or more embodiments, the product DB (104) may be data structure (i.e., one or more lists, tables, collection of data values, etc.) storing information on products associated with (e.g., developed by, being offered by, etc.) the merchant Information on each product may include, but is not limited to: product specifications and data, user manuals, product catalogs and pamphlets, presentation(s) made for a product, pictures of the product, pictures of functions and/or features of the product, the product's specifications, features of a competitor's equivalent product, stock marketing photos, etc.

In one or more embodiments, the product DB (104) may also store one or more keywords in association with one or more of the information on the products. More specifically, in one or more embodiments disclosed herein, the product DB (104) may store keywords with their respective associated products in a key-value pair format (herein referred to as “key-value pair”). These keywords may be stored as the key component (herein referred to as “key”) of the key-value pair while products associated with each keyword may be stored as the value component (herein referred to as “value”) of the key-value pair. In one or more embodiments, keywords may be identified and stored by one or more of the merchant's employees based on their knowledge of the merchant's products and the need of the merchant's customers. The association between the keywords and respective ones of the merchant's products may also be identified and stored by the merchant's employees based on the same information. Additionally, a single keyword may be associated with multiple products. Multiple products may also be associated with the same keyword.

As a non-limiting example of one or more embodiments, assume that the merchant is a seller of laptops and applications (e.g., SaaS) that run on the laptops. The merchant's product DB (104) may store keywords such as, but are not limited to: storage, latency, capacity, backup, battery life, size, etc. Further, assume that the merchant offers at least two types of laptops (e.g., laptop A and laptop B) and two types of applications (e.g., application A and application B). In this example, both laptops may be associated with the keywords storage, capacity, battery life, and size while both applications may be associated with the keywords latency and backup.

In one or more embodiments, any one of the known-voice DB (103) or the product DB (104) may be stored in a device (e.g., another volatile or non-volatile storage or any combination thereof) that is external to and separate and distinct from the storage (102). For example, the device may be a virtual storage (or a physical instance thereof) instantiated on a network device (e.g., a server) operated and maintained by the owner of the product and service.

In one or more embodiments disclosed herein, the system (100) further includes the voice recognition engine (108). The voice recognition engine (108) may be implemented in hardware (i.e., circuitry), software, or any combination thereof. In one or more embodiments, the voice recognition engine (108) may be configured to implement one or more voice recognition techniques through the execution of one or more voice recognition programs and/or applications to identify a customer's voice on a customer call in order to obtain one or more terms (e.g., the search terms) spoken by the customer during the customer call.

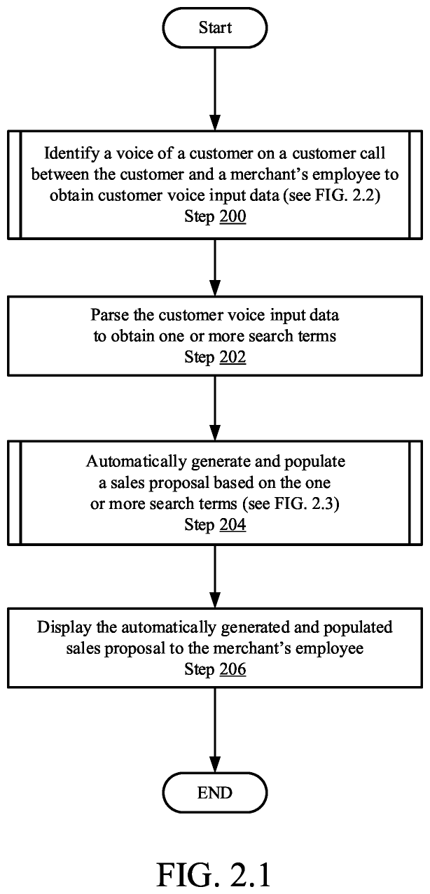

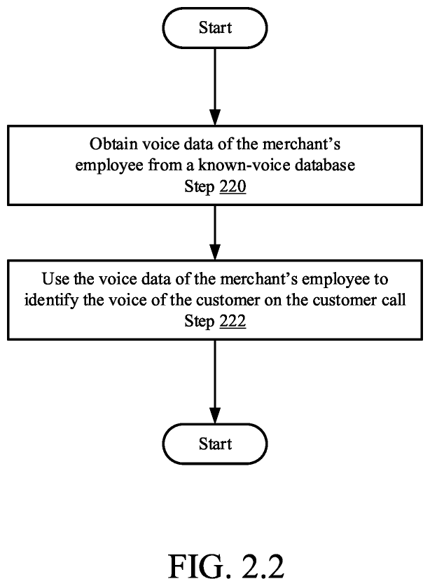

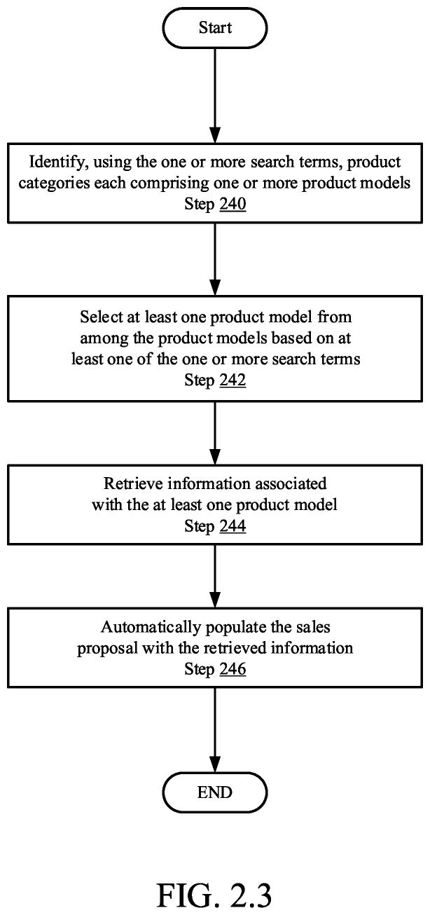

In one or more embodiments, the voice recognition engine (108) may also be trained to identify voices of the merchant's employees and/or customers using the data stored in the known-voice DB (104). Additionally, the voice recognition engine (108) may also be trained, using the data stored in the known-voice DB (104), to ignore the voice of the merchant's employee and focus only on the voice of the customer(s). Additional details of the processes executed by the voice recognition engine (108) are discussed below in FIGS. 2.1-2.3.

In one or more embodiments disclosed herein, the system (100) further includes the keyword matching engine (110). The keyword matching engine (110) may be implemented in hardware (i.e., circuitry), software, or any combination thereof. In one or more embodiments, the keyword matching engine (110) may be configured to match one or more terms (e.g., the search terms) spoken by the customer detected by the voice recognition engine (108) with one or more keywords stored in the product database (DB) (104). Additional details of the processes executed by the text matching engine (110) are discussed below in FIGS. 2.1-2.3.

In one or more embodiments disclosed herein, the system (100) further includes the sales proposal generation engine (112). The sales proposal generation engine (112) may be implemented in hardware (i.e., circuitry), software, or any combination thereof. In one or more embodiments, the display engine (112) may be configured to automatically generate one or more sales proposals using one or more products associated with the predefined keywords identified by the keyword matching engine (110). Additional details of the processes executed by the sales proposal generation engine (112) are discussed below in FIGS. 2.1-2.3.

In one or more embodiments disclosed herein, the system (100) further includes the display engine (114). The display engine (114) may be implemented in hardware (i.e., circuitry), software, or any combination thereof. In one or more embodiments, the display engine (114) may be configured to display (e.g., on a display of the computing device shown in FIG. 4) the automatically generated sales proposal to one of the merchant's employees. Additional details of the display engine (112) are discussed below in FIGS. 2.1-2.3.

Although the system (100) is shown as having five components (102, 108, 110, 112, 114), in other embodiments, the system (100) may have more or fewer components. Further, the functionality of each component described above may be split across components or combined into a single component (e.g., the functionalities of the keyword matching engine (110) and the display engine (114) may be combined to be implanted by a single component. Further still, each component (102, 108, 110, 112, and 114) may be utilized multiple times to carry out an iterative operation.

Turning now to FIGS. 2.1-2.3, FIGS. 2.1-2.3 show flowcharts in accordance with one or more embodiments disclosed herein. The methods depicted in FIGS. 2.1-2.3 may be performed to automatically generate one or more sales proposals using contents of a customer call between a customer and a merchant's employee. The methods shown in FIGS. 2.1-2.3 may be performed, for example, by a combination of the voice recognition engine (e.g., 108, FIG. 1), the keyword matching engine (e.g., 110, FIG. 1), the sales proposal generation engine (e.g., 112, FIG. 1), and the display engine (e.g., 114, FIG. 1). Other components of the system in FIG. 1 may perform all, or a portion, of the methods of FIGS. 2.1-2.3 without departing from the scope of one or more embodiments described herein.

While FIGS. 2.1-2.3 are illustrated as a series of steps, any of the steps may be omitted, performed in a different order, additional steps may be included, and/or any or all of the steps may be performed in a parallel and/or partially overlapping manner without departing from the scope of the embodiments described herein.

Initially, in Step 200, a voice of a customer on a customer call between the customer and a merchant's employee is obtained (e.g., by the voice recognition engine) as customer voice input data. In one or more embodiments, the customer call may be a recording of a live customer call. The recording of the customer call may be retrieved from any source (e.g., the storage (102) of FIG. 1, an external storage, etc.) and may be of any size and length. Alternatively, the customer call may be occurring live.

In one or more embodiments, the customer call may include a single customer and a single merchant's employee. However, one or more embodiments disclosed herein is not limited to this example, and any number of customers and merchant employees may be on the customer call without departing from the scope of one or more embodiments disclosed herein.

In one or more embodiments, the voice(s) of the merchant's employee(s) may be ignored such that the focus is only on the voice(s) or the customer(s) (i.e., such that the voice(s) of the customer(s) may be isolated). This advantageously results in the accurate capturing of the customer's needs and demands by disregarding anything said by the merchant's employee(s). Additional details with regard to how the voice of the customer is obtained and isolated is described below in reference to the flowchart shown in FIG. 2.2.

In Step 202, the customer voice input data is parsed (e.g., by the voice recognition engine) to obtain one or more search terms. In one or more embodiments, the voice recognition engine may be trained beforehand to identify certain words, terms, and/or phrases spoken by a customer. These words, terms, and/or phrases that the voice recognition engine is trained to identify may be used as the search terms that are parsed from the customer voice input data. Additionally, in one or more embodiments, these words, terms, and/or phrases that the voice recognition engine is trained to identify may be preconfigured (e.g., within the storage (102)) by one or more employees associated with the merchant (e.g., employees working in one or more of the merchant's marketing divisions).

In Step 204, a sales proposal is automatically generated and populated (e.g., using a combination of the keyword matching engine and the sales proposal generation engine) based on the one or more search terms identified in Step 202.

In one or more embodiments, the sales proposal may be automatically populated to include at least the top three (3) rated products associated with the one or more search terms. However, one or more embodiments disclosed herein is not limited to this example of using the top three (3) rated products. More specifically, any number of products associated with the one or more search terms may be used to populate the sales proposal without departing from the scope from one or more embodiments disclosed herein.

Additional details and examples showing how the products associated with the search terms are identified and rated are described below in reference to the flowchart shown in FIG. 2.3.

In Step 206, the automatically generated and populated sales proposal is displayed (e.g., by the display engine) to the merchant's employee. The sales proposal may be displayed on a display of a computing device being used by the merchant's employee. The merchant's employee may execute some final fine-tuning and refining of the sales proposal before transmitting a finalized copy of the automatically generated and populated sales proposal to the customer.

Turning now to FIG. 2.2, as discussed above, the voice of the customer is isolated (e.g., by the voice recognition engine) from the other voices occurring on the customer call. This will now be described in more detail below.

In Step 220, voice data associated with the merchant's employee may be obtained from the known-voice database. This voice data may be based on previously recorded versions of the merchant's employees' voices and include information for the voice recognition engine to be able to identify the voice(s) of the merchant's employee(s).

In one or more embodiments, the voice recognition engine may also compare the voice data associated with the merchant's employee(s) to voices occurring within the customer call to match one or more voices occurring on the customer call with the voice data. This advantageously helps the voice recognition engine to easily identify the voice(s) of the merchant's employee(s).

In Step 222, once the voice recognition engine is aware of which voice(s) on the customer call belongs to the merchant's employees, the voice recognition engine is able to use the voice data to identify (e.g., pinpoint on) the voice of the customer(s) on the customer call.

In one or more embodiments, once the voice recognition engine is able to identify (e.g., pinpoint on) the voice of the customer on the customer call, the voice recognition engine may be able to filter the voice(s) of the merchant's employee(s) from the customer call to isolate only the voice of the customer. Alternatively, the voice recognition engine may reference the voice data associated with the merchant's employee to ignore the voice(s) of the merchant's employee(s) on the customer call in order to focus only on the voice of the customer(s).

Yet, in another one of one or more embodiments, the voice recognition engine may be pre-trained (i.e., trained beforehand) with all of the voice data associated with the merchant's employees such that the retrieval of the voice data in Step 220 during a live customer call may be omitted.

Turning now to FIG. 2.3, as discussed above in Step 204 of FIG. 2.1, the sales proposal may be automatically populated to include at least the top three (3) rated products associated with the one or more search terms. A non-limiting example of how at least one of the top three (3) rated products is selected is described below in the steps of the flowchart shown in FIG. 2.3.

Starting with Step 240, one or more product categories are identified using the one or more search terms. In one or more embodiments, each product category may comprise one or more product models.

Additionally, referring back to the key-value pair stored in the product DB (104) described above in reference to FIG. 1, each identified product category may be used to identify key-value pairs with keys that match the one or more search terms. For example, assume that one of the search terms is “capacity” and that a key of one key-value pair stored in the product DB (e.g., 104, FIG. 1) is also “capacity” while the value of the key-value pair is “storage array.” In this example, “storage array” may be associated with a product category. Consequently, the search term “capacity” may first be mapped to the product category of “storage arrays.” The “storage arrays” product category may then include additional key-value pairs with the key “performance” and values such as “PowerStore,” “Unity,” or “Compellent.” Other search terms (e.g., store data, personal workspace, enterprising computing) may map to the same or different ones of the product categories (e.g., storage, laptops, servers, respectively).

As another example, assume that the “storage arrays” product category from the above example includes the key-value pairs (“performance”=PowerStore) and (“hybrid”=Unity). Further assume that another search term identified from the customer call is “hybrid.” In one or more embodiments, based on detecting the term “hybrid” in the customer call, “Unity” may be selected as a result of a determination (e.g., using information associated with each product model “PowerStore” and “Unity”) that “PowerStore” does not have a hybrid option (e.g., function).

In Step 242, at least one product model is selected from among the product models identified in Step 240 based on at least one of the one or more search terms. More specifically, each of the keywords stored in the product DB may be assigned a weight (also referred to herein as a “weight value”). In one or more embodiments, the weight may be any non-negative integer. The keyword, among the keywords that match the one or more search terms, with the largest weight is then selected. If this keyword with the largest weight is associated with only a single product model, the product model is selected as one of the top rated products to be included in the automatically generated sales proposal. Alternatively, if the keyword with the largest weight is associated with multiple product models, information specifying the merchant's business and/or revenue goal(s) will be referenced to select one product model from among the multiple product models. This information specifying the merchant's business and/or revenue goal(s) may also be stored in the product DB as information associated with the product models.

For example, assume that the system determines that the keywords “store data,” “flash,” “capacity,” “performance,” “personal device,” “client laptops,” “compute,” and “disk drives” match the one or more search terms. These keywords are then determined to be associated with the product categories of “storage arrays,” “laptops,” and/or “servers.” It is then determined that the keyword “performance” has the largest weight among the other keywords based on the customer call, and that the product models associated with the keyword “performance” are “PowerStore,” “Unity,” and “Compellent.” It is then further determined that the merchant's goal is to sell at least 10 copies of “PowerStore” in the given timeframe (e.g., month, week, business quarter, etc.) that the customer call occurred while there are no quotas for “Unity” and “Compellent” within the same timeframe. As a result, “PowerStore” will be selected as at least one of the top three (3) rated products to be populated into the automatically generated sales proposal.

In Step 244, information associated with the at least one product model is retrieved from the product DB. As discussed above in reference to FIG. 1, the information associated with the at least one product model may include, but is not limited to: user manuals, product catalogs and pamphlets, presentation(s) made for the product model, pictures of the product model, pictures of functions and/or features of the product model, the product model's specifications, features of a competitor's equivalent product, stock marketing photos, etc. In the context of one or more embodiments disclosed herein, the term “product model” is equivalent to a “product” being offered by the merchant.

In one or more embodiments, reasons for why a customer should purchase a product based on the search terms spoken by the customer (e.g., a customer value) may also be generated to be populated into the sales proposal. For example, a customer may have said “our business is growing 10× over the next year and we need a high-performing storage array to meet our needs,” during the customer call. As a result, a customer value of “[t]his product will accommodate your 10× growth,” will be generated for the sales proposal. Additionally, in one or more embodiments, a reverse timeline may also be generated using the information retrieved from the product DB and a critical date provided by the customer during the customer call (e.g., a go-live date for using the product to be purchased, the end of a fiscal quarter, a customer's self-set purchase deadline, a date that the customer must receive the product, etc.). The reverse timeline may include, for example, but is not limited to: a purchase date of the product, a shipping time for the product, an installation for the product, and the critical date provided by the customer. This may advantageously allow customers to know exactly when they need to take action to order the products to have the products in place by the critical date.

In Step 246, the sales proposal is automatically populated to include the information retrieved in Step 244. In one or more embodiments, multiple templates of the sales proposal (hereinafter referred to as “sales proposal templates”) with different layouts and designs may be stored in the storage (e.g., 102, FIG. 1). The system of one or more embodiments, may determine, based on the information retrieved in Step 244, a most suitable template to be used to include all of the retrieved information. For example, if multiple pictures and/or photos are retrieved as the information, a template with a design and/or layout allowing the inclusion for multiple pictures and/or photos may be selected. Other ways of selecting one or more sales proposal templates to be populated with the information associated with one or more selected products may also be used without departing from the scope of one or more embodiments disclosed herein.

Although a specific example is discussed above in reference to the flowchart shown in FIG. 2.3, one or more embodiments disclosed herein are not limited to this process of selecting a product from the product database. In particular, one of ordinary skill in the art would appreciate that other methods of selecting a most relevant and/or a top rated product based on one or more keywords that match the search terms may be used without departing from the scope of one or more embodiments disclosed herein.

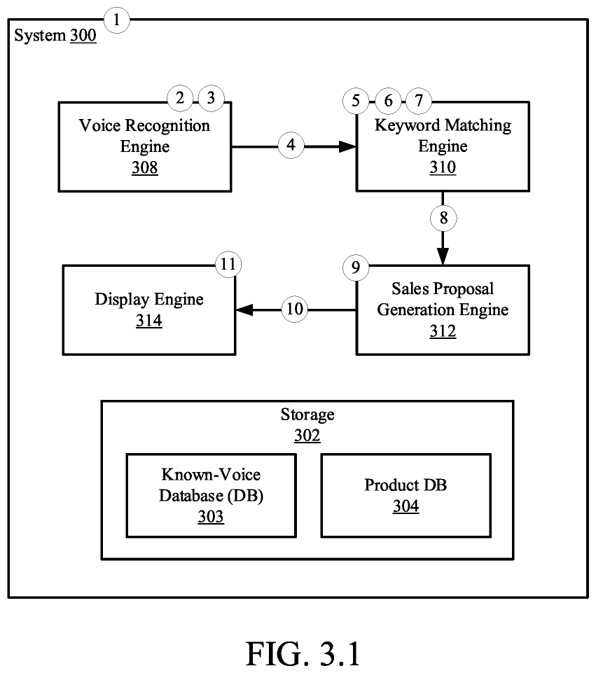

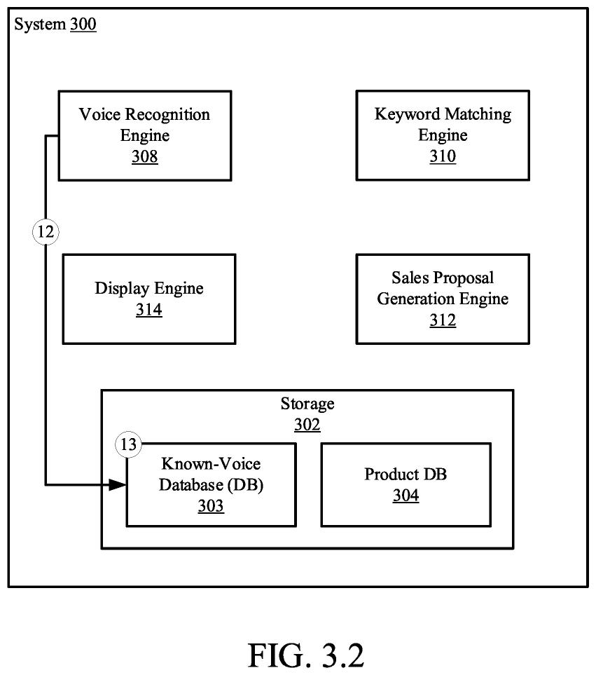

FIGS. 3.1-3.2 show an implementation example in accordance with one or more embodiments. In particular, FIGS. 3.1-3.2 shows an example of generating a self-guided troubleshooting guide and how the assistance request DB is updated after the generation and use of the self-guided troubleshooting guide. The numbers in the brackets below, e.g., “[1]”, correspond to the same circled numbers in FIGS. 3.1-3.2.

### Beginning of Example

Initially, as shown in FIG. 3.1, the system (300) (e.g., system 100, FIG. 1) is notified (or obtains) a customer call between a customer and a merchant's employee [1]. In response to the notification, the voice recognition engine (308) (e.g., 108, FIG. 1) parses the customer call to extract customer voice input data [2]. The voice recognition engine (308) then parses the customer voice input data to obtain one or more search terms [3]. The one or more search terms are then sent from the voice recognition engine (308) to the keyword matching engine (310) (e.g., 110, FIG. 1) [4].

Once the keyword matching engine (310) receives the one or more search terms, the keyword matching engine compares the one or more search terms to key-value pairs stored in the product database (DB) (304) (e.g., 104, FIG. 1) to find keywords that most closely match the one or more search terms [5]. The keyword matching engine (310) then determines the top three (3) rated products based on the keywords that most closely match the one or more search terms [6]. Once the products are identified, the keyword matching engine (310) retrieves information about each identified product from the product DB (304) [7]. The retrieved information about each identified product is then transmitted to the sales proposal generation engine (312) [8].

In receiving the information about each identified product from the keyword matching engine (310), the sales proposal generation engine automatically populates a sales proposal template form with the received information [9]. The automatically populated sales proposal is then transmitted to the display engine (314) [10]. The display engine (314) then displays the automatically populated sales proposal to the merchant's employee on a display of a computing device [11].

Turning now to FIG. 3.2, in parallel with or after some time has passed since the events in FIG. 3.1, the voice recognition engine (308) transmits the customer voice input data to the known-voice DB (303) (e.g., 103, FIG. 1). The customer voice input data is stored in the known-voice DB (303) to be used to train the voice recognition engine (308) for future customer calls [13].

### End of Example

FIG. 4 shows a computer system in accordance to one or more embodiments.

Embodiments disclosed herein may be implemented using computing devices and/or computing systems. FIG. 4 shows a diagram of a computing device in accordance with one or more embodiments disclosed herein. Computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, computer processor(s) (402) may be an integrated circuit for processing instructions. For example, the computer processor(s) may be one or more cores or micro-cores of a processor. Computing system (400) may also include one or more input devices (410), such as a touchscreen, keyboard, mouse, microphone, touchpad, electronic pen, or any other type of input device. Further, communication interface (412) may include an integrated circuit for connecting computing system (400) to a network (not shown) (e.g., a local area network (LAN), a wide area network (WAN) such as the Internet, mobile network, or any other type of network) and/or to another device, such as another computing system.

In one embodiment disclosed herein, computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to computer processor(s) (402), non-persistent storage (404), and persistent storage (406). Many different types of computing devices exist, and the aforementioned input and output device(s) may take other forms.

Embodiments disclosed herein may provide a less resource-intensive and accurate process for merchants to generate sales proposals for customers. More specifically, sales proposals are manually created, which take up time and decrease efficiency when having to build out a complete proposal for each of the merchant's customers. Additionally, contents for these sales proposals usually come from a merchant's employee's handwritten notes and interpretations of a customer's requirements, both of which can be misconstrued by an individual employee. However, one or more embodiments disclosed herein are able to automatically generate sales proposals without any user intervention (e.g., without a merchant's employee having to find the relevant products based on the customer's input and manually filing out a sales proposal). This advantageously removes any human error (e.g., different interpretations by different merchant's employees, mishearing a customer's words by the merchant's employees, merchant's employee's bias, etc.) from the process of generating sales proposals, and results in a direct improvement in the efficiency and accuracy of the sales proposal generation process.

The problems discussed above should be understood as being examples of problems solved by one or more embodiments disclosed herein and the one or more embodiments disclosed herein should not be limited to solving the same/similar problems. In particular, one or more embodiments disclosed herein are broadly applicable to address a range of problems beyond those discussed herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for automated generation of a sales proposal using customer voice input data, the method comprising:
identifying, automatically using voice recognition, a customer's voice within a customer call between a customer and a merchant's employee to obtain customer voice input data;
parsing the customer voice input data to obtain one or more search terms;
automatically generating and populating a sales proposal based on the one or more search terms; and
displaying, after the automatic generating and populating, the sales proposal to the merchant's employee, wherein the sales proposal is to be presented to the customer by the merchant's employee.

2. The method of claim 1, wherein identifying the customer's voice within the customer call to obtain the customer voice input data comprises:
obtaining voice data of the merchant's employee from a known-voice database; and
filtering, automatically using the voice recognition, the voice data of the merchant's employee from the customer call to isolate the customer's voice.

3. The method of claim 1, wherein identifying the customer's voice within the customer call to obtain the customer voice input data comprises:
obtaining voice data of the merchant's employee from a known-voice database; and
referencing, automatically using the voice recognition, the voice data of the merchant's employee to ignore a voice of the merchant's employee on the customer call in order to focus only on the customer's voice.

4. The method of claim 2, wherein the customer's voice is saved and stored into the known-voice database for future ones of the customer calls with the customer.

5. The method of claim 1, wherein automatically generating and populating the sales proposal based on the one or more search terms comprises:
identifying, using the one or more search terms, a product category of one or more products to be offered by the merchant's employee to the customer, wherein the product category is associated with a plurality of product models; and
identifying, after identifying the product category and using the one or more search terms, a product model among the plurality of product models; and
automatically populating information associated with the product model in the sales proposal.

6. The method of claim 5,
wherein the one or more search terms match one or more keywords stored in a product database, and
wherein the voice recognition is trained to identify the one or more search terms.

7. The method of claim 6,
wherein each of the one or more keywords is a key component of a key-value pair stored in the product database, and
wherein a value component of the key-value pair is the one or more products to be offered by the merchant's employee to the customer.

8. The method of claim 6,
wherein the product category is one of a plurality of product categories associated with a first keyword among the one or more keywords that matched with the one or more search terms,
wherein each of the keywords is assigned a weight, and
wherein automatically generating and populating the sales proposal based on the one or more search terms comprises:
determining a second keyword, among the one or more keywords that matched with the one or more search terms, that comprises a largest weight value;
identifying that the second keyword with the largest weight value is associated with the plurality of product models; and
selecting the product model from among the plurality of product models.

9. The method of claim 8, wherein selecting the product model from among the plurality of product models comprises:
identifying sales goal information associated with the plurality of product models; and
selecting the product model from among the plurality of product models based on the sales goal information,
wherein the sales goal information is stored with the product model in the product database, and
wherein the sales goal information specifies that the product model should be marketed to the customer with higher priority than a remainder of the product models.

10. The method of claim 1, wherein the customer call is being conducted in real time.

11. A non-transitory computer readable medium (CRM) comprising computer readable program code, which when executed by a computer processor enables the computer processor to perform a method for automated generation of a sales proposal using customer voice input data, the method comprising:
identifying, automatically using voice recognition, a customer's voice within a customer call between a customer and a merchant's employee to obtain customer voice input data;
parsing the customer voice input data to obtain one or more search terms;
automatically generating and populating a sales proposal based on the one or more search terms; and
displaying, after the automatic generating and populating, the sales proposal to the merchant's employee, wherein the sales proposal is to be presented to the customer by the merchant's employee.

12. The CRM of claim 11, wherein identifying the customer's voice within the customer call to obtain the customer voice input data comprises:
obtaining voice data of the merchant's employee from a known-voice database; and
filtering, automatically using the voice recognition, the voice data of the merchant's employee from the customer call to isolate the customer's voice.

13. The CRM of claim 11, wherein identifying the customer's voice within the customer call to obtain the customer voice input data comprises:
obtaining voice data of the merchant's employee from a known-voice database; and
referencing, automatically using the voice recognition, the voice data of the merchant's employee to ignore a voice of the merchant's employee on the customer call in order to focus only on the customer's voice.

14. The CRM of claim 12, wherein customer's voice is saved and stored into the known-voice database for future ones of the customer calls with the customer.

15. The CRM of claim 11, wherein automatically generating and populating the sales proposal based on the one or more search terms comprises:
identifying, using the one or more search terms, a product category of one or more products to be offered by the merchant's employee to the customer, wherein the product category is associated with a plurality of product models; and
identifying, after identifying the product category and using the one or more search terms, a product model among the plurality of product models; and
automatically populating information associated with the product model in the sales proposal.

16. A system comprising:
a memory; and
a processor coupled to the memory, wherein the processor is configured to execute a method for automated generation of a sales proposal using customer voice by:
identifying, automatically using voice recognition, a customer's voice within a customer call between a customer and a merchant's employee to obtain the customer voice input data;
parsing the customer voice input data to obtain one or more search terms;
automatically generating and populating the sales proposal based on the one or more search terms; and
displaying, after the automatic generating and populating, the sales proposal to the merchant's employee, wherein the sales proposal is to be presented to the customer by the merchant's employee.

17. The system of claim 16, wherein identifying the customer's voice within the customer call to obtain the customer voice input data comprises:
obtaining voice data of the merchant's employee from a known-voice database; and
filtering, automatically using the voice recognition, the voice data of the merchant's employee from the customer call to isolate the customer's voice.

18. The system of claim 16, wherein identifying the customer's voice within the customer call to obtain the customer voice input data comprises:
obtaining voice data of the merchant's employee from a known-voice database; and
referencing, automatically using the voice recognition, the voice data of the merchant's employee to ignore a voice of the merchant's employee on the customer call in order to focus only on the customer's voice.

19. The system of claim 17, wherein customer's voice is saved and stored into the known-voice database for future ones of the customer calls with the customer.

20. The system of claim 16, wherein automatically generating and populating the sales proposal based on the one or more search terms comprises:
identifying, using the one or more search terms, a product category of one or more products to be offered by the merchant's employee to the customer, wherein the product category is associated with a plurality of product models; and
identifying, after identifying the product category and using the one or more search terms, a product model among the plurality of product models; and
automatically populating information associated with the product model in the sales proposal.
